(19) United States
(12) Patent Application Publication
(10) Pub. No.: US 2013/0258473 A1
(43) Pub. Date: Oct. 3, 2013

(54) STOWABLE LENS CAP FOR OPTICAL DEVICE

(71) Applicant: Gregory Seth BANDY, Roanoke, VA (US)

(72) Inventor: Gregory Seth BANDY, Roanoke, VA (US)

(73) Assignee: EXELIS, INC, McLean, VA (US)

(21) Appl. No.: 13/438,396

(22) Filed: Apr. 3, 2012

(51) Int. Cl. G03B 11/04

(52) U.S. Cl. 359/511

(57) ABSTRACT

A removable lens cap for an optical device includes a lens cap body having one or more walls defining an interior space on one side of the lens cap body that is configured to conceal a lens of the optical device; and provisions for removably mounting the lens cap body to the optical device that is defined on a different side of the lens cap body.

### FIELD OF THE INVENTION

This invention relates to a lens cap for an optical device.

### BACKGROUND OF THE INVENTION

Lens caps that are removably mounted to an optical device are often misplaced by the end user once they are removed from the optical device. Alternatively, lens caps that are tied to the optical device by a lanyard and dangle from the optical device can be obtrusive, and are capable of bouncing around or becoming snagged on another object during use of the optical device. The invention disclosed herein offers a convenient and practical solution for stowing a removable lens cap on the body of an optical device while the optical device is in use. In particular, this invention is particularly useful for a fused night vision device that has two lenses, i.e., one lens for the Infrared (IR) channel and the other lens for the image intensification channel, where the probability of losing a lens cap is twice as likely.

### SUMMARY OF THE INVENTION

According to one aspect of the invention, a removable lens cap for an optical device includes a lens cap body having one or more walls defining an interior space on one side of the lens cap body that is configured to conceal a lens of the optical device; and means for removably mounting the lens cap body to the optical device that is defined on a different side of the lens cap body.

According to another aspect of the invention, a fused night vision device assembly comprises a device body; two optical lenses positioned on the device body that are separated by a pre-determined distance; a lens cap mount, which is separate from the two lenses, that is defined on the device body; and a removable lens cap that is configured to be removably connected over the two lenses to conceal the lenses and is also configured to be removably connected to the lens cap mount.

According to yet another aspect of the invention, a removable lens cap for a fused night vision optical device includes a lens cap body including a first cap portion and a second cap portion that are spaced apart by a pre-determined distance, each cap portion having one or more walls defining an interior space on one side of the lens cap body that is configured to conceal a lens of the optical device; and means for removably mounting the lens cap body to the fused night vision optical device, said means for removably mounting being defined on a different side of the lens cap body.

### BRIEF DESCRIPTION OF THE DRAWING FIGURES

The invention is best understood from the following detailed description when read in connection with the accompanying drawing. Included in the drawing are the following figures:

FIG. 1A depicts a perspective view of a lens cap mounted over the lenses of a fused night vision optical device.

FIG. 1B depicts a perspective view of the lens cap stowed on the fused night vision optical device.

FIGS. 2A and 2B depict front and rear perspective views, respectively, of the lens cap of FIGS. 1A and 1B.

FIG. 3 depicts a front elevation view of the lens cap.

FIG. 4 depicts a rear elevation view of the lens cap.

FIG. 5 depicts a cross-sectional side view of the lens cap of FIG. 4 taken along the lines 5-5.

### DETAILED DESCRIPTION OF THE DRAWING FIGURES

The invention is best understood from the following detailed description when read in connection with the accompanying drawing figures, which shows exemplary embodiments of the invention selected for illustrative purposes. The invention will be illustrated with reference to the figures. Such figures are intended to be illustrative rather than limiting and are included herewith to facilitate the explanation of the present invention.

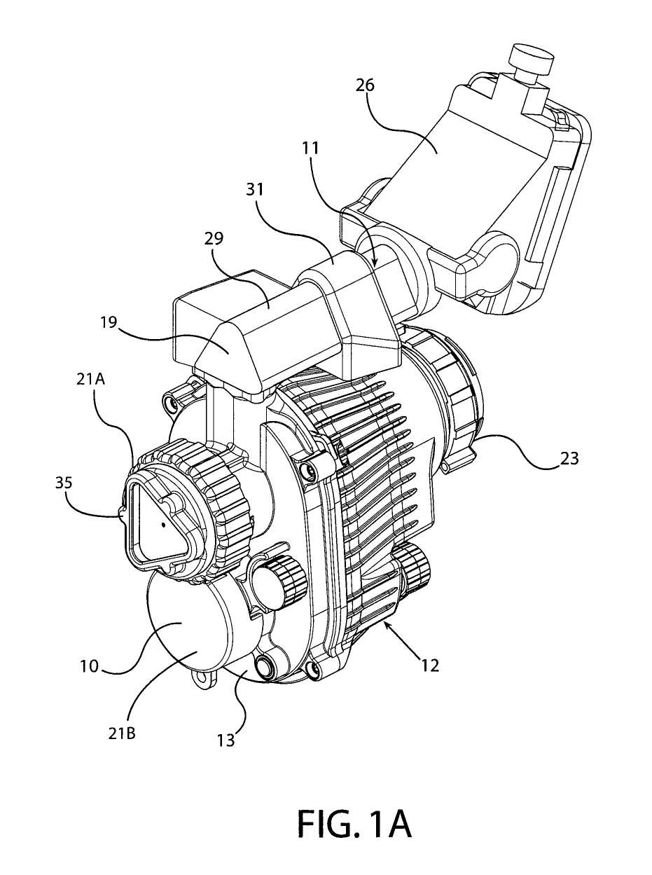

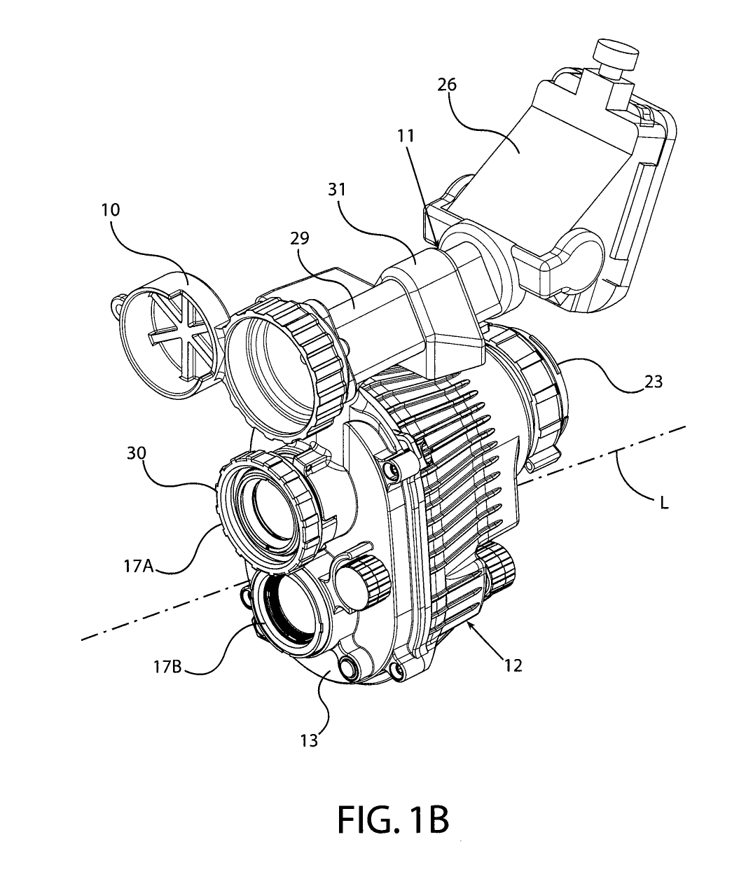

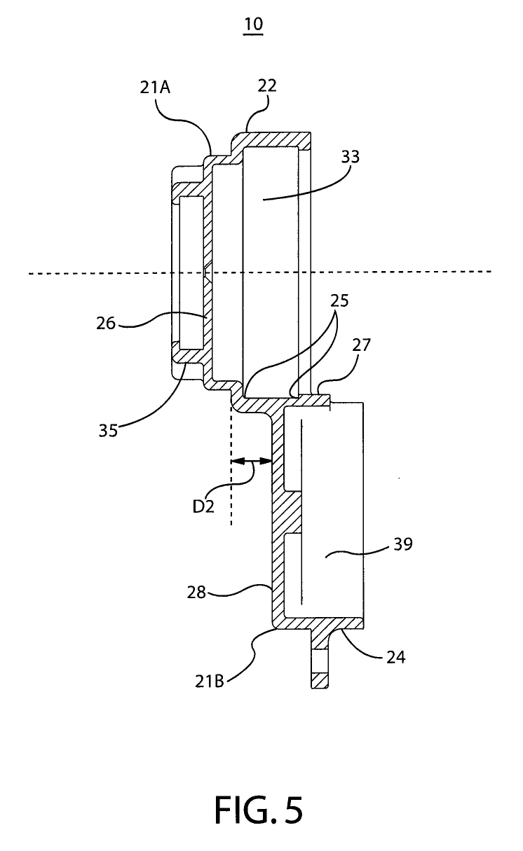

Referring generally to the drawing figures, and according to one aspect of the invention, a removable lens cap 10 for an optical device includes a lens cap body 20 having one or more walls defining an interior space 33 and 39 (See FIG. 5) on one side of the lens cap body 20 that is configured to conceal a lens 17A and 17B (See FIG. 1B) of the optical device; and means 35 for removably mounting the lens cap body 20 to the optical device that is defined on a different side of the lens cap body 20.

According to another aspect of the invention, a fused night vision device assembly comprises a device body 13; two optical lenses 17A and 17B positioned on the device body 13 that are separated by a pre-determined distance; a lens cap mount 19, which is separate from the two lenses 17A and 17B, that is defined on the device body 13; and a removable lens cap 10 that is configured to be removably connected over the two lenses 17A and 17B to conceal the lenses 17A and 17B and is also configured to be removably connected to the lens cap mount 19.

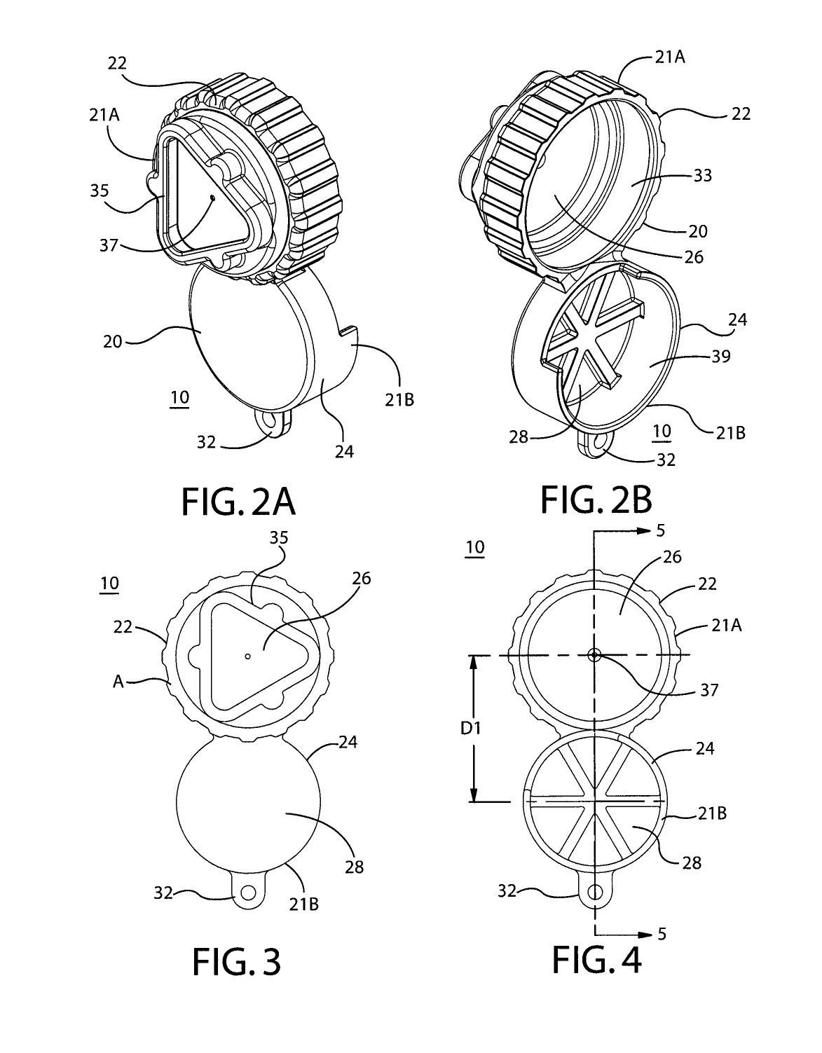

According to yet another aspect of the invention, a removable lens cap 10 for a fused night vision optical device includes a lens cap body 20 including a first cap portion 21A and a second cap portion 21B (see FIGS. 2A, 2B and 4) that are spaced apart by a pre-determined distance D1, each cap portion 21A and 21B having one or more walls 22 and 24 defining an interior space 33 and 39 on one side of the lens cap body 10 that is configured to conceal a lens 17A and 17B of the optical device, respectively; and means 35 for removably mounting the lens cap body 20 to the fused night vision optical device, said means 35 for removably mounting being defined on a different side of the lens cap body 20.

Referring specifically to FIGS. 1A and 1B, FIG. 1A depicts a perspective view of a lens cap 10 mounted over the lenses of a fused night vision optical device 12 (hereinafter NV device 12), and FIG. 1B depicts a perspective view of the lens cap 10 stowed on the NV device 12. The lens cap 10 is removably mountable to the lenses 17A and 17B of the NV device 12 (compare FIGS. 1A and 1B). The NV device 12 includes a body 13 which houses two lenses 17A and 17B (referred to either individually or collectively as lenses 17). The lenses 17 are separated by a pre-determined distance. One lens 17 is associated with an Infrared channel of the NV device 12, and the other lens 17 is associated with an image intensification channel of the NV device 12. Fused night vision devices having two lenses are known, and disclosed, for example, in U.S. Pat. No. 7,116,491 to Willey et al., which is incorporated by reference herein in its entirety.

The NV device 12 is mounted to a helmet (not shown) by a helmet connection mechanism 11. The helmet connection mechanism 11 is configured to connect the NV device 12 to a helmet such that the eye piece 23 of the device 12 is positioned directly before the eyes of a person who is wearing the helmet. The helmet connection mechanism 11 is releasably mounted to the device 12 and the helmet.

The helmet connection mechanism 11 includes a helmet connector 26 that is configured to be releasably connected to a helmet, a triangular rail 29 that projects from the helmet connector 26, and a bracket 31 that is capable of sliding along the length of the triangular rail 29. The bottom surface of the bracket 31 includes a connector (not shown) that is configured to be releasably connected to the top end of the NV device 12.

The helmet connection mechanism 11 and the body 13 of the NV device 12 may be separate components that are mounted together, or those components may be integrated together. Thus, the helmet connection mechanism 11 may be considered as forming part of the NV device 12.

As shown in FIG. 1A, the free end surface of the triangular rail 29 defines a lens cap mount 19, which may also be referred to herein as a connector or as a lens cap mount. The lens cap mount 19 is configured to releasably retain the lens cap 10 in a fixed position. According to this embodiment, the lens cap mount 19 is a triangular-shaped protrusion that is sized to be friction fitted within a mating triangular-shaped protrusion 35 of the lens cap 10. The lens cap mount 19 may vary from that which is shown and described. Generally, the lens cap mount 19 may be any mechanism that is configured to releasably retain the lens cap 10, such as a surface having any shape, a protrusion having any shape, a recess having any shape, a clip, a connector, Velcro, a detent, a fastener, a clamp, a snap, a button, a buckle, a magnet, an adhesive, a mechanical thread, for example, or any other mechanism that is known to those of ordinary skill in the art.

The lens cap 10 is positioned to conceal the lenses 17 of the NV device 12 to prevent the accumulation of dust, dirt, etc., on the outer surfaces of the lenses 17. The lens cap 10 is depicted by itself in FIGS. 2A-5.

Referring specifically to FIGS. 2A-5, the lens cap 10 includes a one-piece lens body 20. The lens body 20 is optionally a one-piece injection molded plastic component. Those of ordinary skill in the art will recognize that the lens cap 10 may be composed of any known material and may be formed by any conventional process.

The lens body 20 has a substantially open-ended figure-eight shape defining two open-ended cap portions 21A and 21B. In use, the first cap portion 21A is configured to conceal the upper lens 17A, whereas the second cap portion 21B is configured to conceal the lower lens 17B.

The first cap portion 21A includes a cylindrical wall 22, one end of which is free and the other end of which intersects a circular wall 26. The outer surface of the cylindrical wall 22 is fluted, as shown, such that it can be easily grasped by a user. The circular wall 26 closes one end of the first cap portion 21A, thereby defining a hollow interior space 33 that is sized to accommodate a cylindrically-shaped boot 30 of the upper lens 17A (see FIG. 1B). An annular recess 25 is formed on the interior surface of the cylindrical wall 22. The annular recess 25 is sized to releasably receive the cylindrically-shaped boot 30 of the lens 17A. By virtue of the engagement between the surfaces of the annular recess 25 and the boot 30, the entire lens cap 10 remains fixed in position over the lenses 17 of the NV device 12.

A hole 37 is provided on the center of the circular wall 28. The hole 37 is intended to maintain the device-facing side of the lens cap 10 at atmospheric pressure when the lens cap 10 is mounted to either the NV device 12 or the lens cap mount 19.

A lens cap mounting means 35 protrudes from the exterior facing surface of the circular wall 26 of the first lens cap portion 21A. According to this exemplary embodiment, the lens cap mounting means 35 is a perfect triangle having three equal internal angles of 60 degrees. The lens cap mounting means 35 is sized to be friction fitted onto the lens cap mount 19 of the helmet connection mechanism 11. Although not shown, the lens cap mounting means 35 may be provided on the second lens cap portion 21B.

The lens cap mount 19 of the helmet connection mechanism 11 and the lens cap mounting means 35 of the lens cap 10 are configured to be mated to each other. Like the lens cap mount 19 of the helmet connection mechanism 11, the lens cap mounting means 35 on the lens cap 10 may vary from that which is shown and described. Generally, the lens cap mounting means 35 may be any mechanism that is configured to releasably retain the lens cap 10, such as a surface having any shape, a protrusion having any shape, a recess having any shape, a clip, a connector, Velcro, a detent, a fastener, a clamp, a snap, a button, a buckle, a magnet, an adhesive, a mechanical thread, for example, or any other mechanism that is known to those of ordinary skill in the art.

Due to the triangular geometry of the lens cap mount 19 and the lens cap mounting means 35, the lens cap 10 may be stowed in three different orientations on the helmet connection mechanism 11, i.e., each orientation being separated apart by 60 degrees. In this embodiment, the distance between the upper lens 17A and the stowed lens cap 10 is sufficiently large that the lens cap 10 can not obstruct the viewing angle of the upper lens 17A in any of the stowed orientations of the lens cap 10. However, if the distance between the upper lens 17A and the stowed lens cap 10 were to be reduced, the lens cap mount 19 and the lens cap mounting means 35 could be together configured to prevent the lens cap 10 from obstructing the upper lens 17A when the lens cap 10 is stowed on the lens cap mount 19.

Referring still to FIGS. 2A-5, the second cap portion 21B includes a cylindrical wall 24, one end of which is free and the other end of which intersects a circular wall 28. The circular wall 28 closes one end of the second cap portion 21B, thereby defining a hollow interior space 39 that is sized to be positioned over the lower lens 17B. The inner diameter of the cylindrical wall 24 is slightly larger than the outer diameter of lens 17B. The second cap portion 21B is not fixedly connected to the lower lens 17B, however, the second cap portion 21B could be modified to be releasably connected to the lower lens 17B.

A boss 32 having a thru-hole formed therein extends from the outer surface of the second cap portion 21B. Although not shown, a lanyard could be tied to the hole in the boss 32 in the event that a user desires to attach the lens cap 10 to the NV device 12 or any other device using the lanyard.

The longitudinal axes of the circular walls 26 and 28 are spaced apart in a radial direction along the lens body 20 by a distance D1. (see FIG. 4). The distance D1 is equivalent to the distance along an axis that is perpendicular to the longitudinal axis ‘L’ of the NV device 12 (See FIG. 1B) that separates the lenses 17 of the NV device 12. The circular walls 26 and 28 are also spaced apart in an axial direction along the lens body 20 by a distance D2 (See FIG. 5). The distance D2 is equivalent to the distance along the longitudinal axis ‘L’ of the NV device 12 that separates the lenses 17 of the NV device 12. The cylindrical walls 22 and 24 of the lens cap portions 21A and 21B, respectively, intersect at a common area 27.

While preferred embodiments of the invention have been described herein, it will be understood that such embodiments are provided by way of example only. Numerous variations, changes and substitutions will occur to those skilled in the art without departing from the spirit of the invention. For example, the lens cap may be applied to any optical device having two lenses and is not limited for use with a night vision device. It is intended that the appended claims cover all such variations as fall within the spirit and scope of the invention.

What is claimed:

1. A removable lens cap for an optical device comprising:
a lens cap body having one or more walls defining an interior space on one side of the lens cap body that is configured to conceal a lens of the optical device; and
means for removably mounting the lens cap body to the optical device that is defined on a different side of the lens cap body.

2. The removable lens cap of claim 1, wherein the lens cap body includes a first cap portion and a second cap portion, each cap portion being configured to be positioned over a separate lens of the optical device.

3. The removable lens cap of claim 2, wherein the first cap portion and the second cap portion are spaced apart both axially and radially along a longitudinal axis of the lens cap body.

4. The removable lens cap of claim 2, wherein each cap portion includes one or more walls defining separate interior spaces.

5. The removable lens cap of claim 1, said means for removably mounting being configured to be mounted to the optical device in more than one orientation of the lens cap.

6. The removable lens cap of claim 1, said means for removably mounting being a protrusion that is sized and shaped to mate with a lens cap mount on the optical device.

7. The removable lens cap of claim 6, said protrusion being a raised triangular surface that extends from said different side of the lens cap body.

8. The removable lens cap of claim 1 further comprising a recess formed in a wall of said one or more walls of the lens cap body, said recess being sized to releasably retain a lens of the optical device or a component that is positioned adjacent the lens of the optical device.

9. A fused night vision device assembly comprising:
a device body;
two optical lenses positioned on the device body that are separated by a pre-determined distance;
a lens cap mount, which is separate from the two lenses, that is defined on the device body; and
a removable lens cap that is configured to be removably connected over the two lenses to conceal the lenses and is also configured to be removably connected to the lens cap mount.

10. The fused night vision device assembly of claim 9, wherein the lens cap includes a first cap portion and a second cap portion, each cap portion being configured to be positioned over a separate lens of the device.

11. The fused night vision device assembly of claim 10, wherein the first cap portion and the second cap portion are spaced apart both axially and radially along a longitudinal axis of the lens cap.

12. The fused night vision device assembly of claim 9, said lens cap being configured to be removably mounted to said lens cap mount in more than one orientation.

13. The fused night vision device assembly of claim 9 further comprising a recess formed in a wall of the lens cap, said recess being sized to releasably retain either a lens of the device or a component that is positioned adjacent the lens of the device.

14. A removable lens cap for a fused night vision optical device comprising:
a lens cap body including a first cap portion and a second cap portion that are spaced apart by a pre-determined distance, each cap portion having one or more walls defining an interior space on one side of the lens cap body that is configured to conceal a lens of the optical device; and
means for removably mounting the lens cap body to the fused night vision optical device, said means for removably mounting being defined on a different side of the lens cap body.

15. The removable lens cap of claim 14, wherein the first cap portion and the second cap portion are spaced apart both axially and radially along a longitudinal axis of the lens cap body.

16. The removable lens cap of claim 14, said means for removably mounting being configured to be mounted to the fused night vision optical device in more than one orientation of the lens cap.

17. The removable lens cap of claim 14, said means for removably mounting being a protrusion that is sized and shaped to mate with a mating connector on the fused night vision optical device.

18. The removable lens cap of claim 17, said protrusion being a raised triangular surface that protrudes from said different side of the lens cap body.

19. The removable lens cap of claim 14 further comprising a recess formed in a wall of said one or more walls of one of the cap portions of the lens cap body, said recess being sized to releasably retain either a lens of the device or a component that is positioned adjacent the lens of the device.
